(19) United States
(12) Patent Application Publication
(10) Pub. No.: US 2009/0300526 A1
(43) Pub. Date: Dec. 3, 2009

(54) Computer based method for creation, personalization, and fulfillment of customizable art printed on canvas

(75) Inventor: Abigail Mills Port, Woodstock, GA (US)

Correspondence Address: Abigail Port, 125 Highlands Drive, Woodstock, GA, 30188, US

(73) Assignee: Mrs. Abigail Port, Woodstock, GA (US)

(21) Appl. No.: 12/130,648

(22) Filed: May 30, 2008

(51) Int. Cl. G06F 3/048

(52) U.S. Cl. 715/764

(57) ABSTRACT

A computer based method of offering customized art to a user. The method comprises of using a collection of digital images and design elements organized in an online flash application generating a customized digital image representation of the art product. Steps include: (a) digital image selection; (b) canvas size selection; (c) canvas background color selection; (d) option to include text; (e) frame selection; and the (f) generation of a digital file ready for print consisting of the image designed through the flash application and available through an internet website and/or retail kiosk.

### FIELD OF THE INVENTION

This invention relates generally to the field of digital imaging. More specifically, the invention relates to a method of offering customized art.

### BACKGROUND OF THE INVENTION

The purchase of goods and services over the internet has grown in volume tremendously over the past 5 years. More and more women are buying items for their homes via décor based websites. There has also been a movement into customized products. Technology today allows people to design items such as t-shirts and purses from start to finish, while sitting at home in front of a computer. Based on the trends today, the concept of providing consumers a process to customize their art from start to finish fills a void in the marketplace.

The web based companies offering personalization of art are limited to adding some text, usually with a predetermined location, and/or choosing from a few pre-determined sizes. Currently, there are no electronic commerce sites providing customized art offering user choice of canvas size, canvas color, placement of a digital image, insertion and placement of user defined text with choice of font, color, shadow, italic, and bold, and framing, all within one flash application with an easy to follow process.

The present invention provides a method directed at overcoming the limitations of art by employing a system to customize and personalize art for the individual user.

### SUMMARY OF THE INVENTION

The invention discloses a method and process for enabling selection, customization, personalization, and framing of art by the user via an internet based application.

An ecommerce user connects to the invented art designer through a website or kiosk.

The user may select from a menu of products including; but not limited to: Build Your Own, Birth Announcements, and Wonderful Words. The user customizes the art by adding a digital artist rendering (also referred to as an image) and/or text to the digitally displayed canvas in the preview window, selecting a canvas background color, selecting a canvas size, and choosing to gallery wrap or place a frame on the completed customized art. After purchase, the digital file generated by the online designer application is sent to a giclee' printer, framed (if selected by user), and shipped.

The first implementation of the invention is the “Build Your Own” option. This method enables a user to: 1) choose an image from the database of hand drawn/painted digitized artist renderings; 2) choose a canvas size based on the length and width of the canvas; 3) select a canvas background color from the list of suggested colors for the image chosen or from a color grid; 4) insert text and choose the font, font color, and style through menus, and manipulate the size and placement by clicking on the text box on the designer generated preview of the canvas; and 5) choose to gallery wrap or frame the completed art. If Gallery wrap is chosen by the user, the flash application adds two inches of background color on each side of the completed art for wrapping around 1.5 inch stretcher bars. If framing, the flash application will provide a selection of frames viewable as a complete frame around the digital display of the user designed art. 6) To complete the order the user will place the digital custom art file into the shopping cart and complete the purchase. A work order and file are generated for production purposes.

The second implementation of the invention is the “Birth Announcement” option. This method enables the user to: 1) choose from a template or predetermined layout of the art; 2) insert an image from the database of hand drawn/painted digitized artist renderings into the designated spot on the template; 3) choose a canvas size based on the length and width of the canvas; 4) select a canvas background color from the list of suggested colors for the image chosen or from a color grid; 5) customize the text on the template and choose the font, font color, and style through menus, and manipulate the size and placement by clicking on the text box on the digital display of the customized art; 5) choose to gallery wrap or flame the completed art. If Gallery wrap is chosen by the user, the flash application will add two inches of background color on each side of the completed piece for wrapping around 1.5 inch stretcher bars. If framing, the flash application will provide a selection of frames viewable as a complete frame around the digital display of the user designed art. 6) To complete the order the user will place the digital custom art file into the shopping cart and complete the purchase. A work order and file are generated for production purposes.

The third implementation of the invention is the “Wonderful Words” option. This method enables a user to: 1) choose a canvas size based on the length and width of the canvas; 2) select a background pattern from a database of hand drawn/painted digitized artist renderings or a solid color from the color grid; 3) insert text from a list of provided words or insert custom text and choose the font, font color, and style through menus, and manipulate the size and placement by clicking on the text box on the digital display of the canvas; 4) choose to gallery wrap or frame the completed art. If Gallery wrap is chosen by the user, the flash application will add two inches of background color on each side of the completed piece for wrapping around 1.5 inch stretcher bars. If framing, the flash application will provide a selection of frames viewable as a complete frame around the user designed art. 6) To complete the order the user will place the digital custom art file into the shopping cart and complete the purchase. A work order and file are generated for production purposes.

### DETAILED DESCRIPTION

This method of producing art creates a truly customizable product for the user. Offering a web-based platform allowing the user to customize art by choosing a digitized artist rendering, placing the image on a digitally displayed canvas, and providing a selection of the canvas sizes and background colors, in addition to customized text, creates a truly unique and one of a kind work-of-art. The steps demonstrated in FIG. 1-14 illustrate the process and method of designing the customized art.

The user will access the flash art designer application through the internet or a kiosk as shown in FIG. 1. The flash application is uploaded to the user's computer or kiosk for the duration of the user's designing process. Once the website is closed, the art designer is no longer accessible to the user.

The art designer has been created as a flash application. All data (except user account information) are stored as JSON encoded objects, currently using some simple tables in a database. The image library consists of swf/jpg/gif/png files. The completed designs will be saved as PDF files ready for print.

This technology is not new, it is the process and the method of applying the technology to custom designed art in a simple to use web-based application that is new and different. Once the user has access to the art designer application they will choose from one of the three product categories currently being offered: Build Your Own, Baby Announcements, and Wonderful Words. In all three modes the user will begin by choosing a digitized artist rendering from the image library as shown in FIG. 2. Each image was hand-painted or drawn by an artist and then converted into a high resolution digital file. The digital file was uploaded into the image library and made available for the user to design their art. The user will choose an image by clicking on the thumbnail in the Artwork menu on the left side of the digital canvas display area. When an image is chosen it will appear on the digital canvas displayed in the preview window as shown in FIG. 3. The user will have the option to move the image to any point on the canvas in addition to sizing or rotating it as shown in FIG. 4. There image Properties tab, as shown in FIG. 5, will provide the option of moving the image layer forward or backward allowing the user to place text over the image. The user will also have the option to delete the image from the canvas.

After choosing an image, the user selects a canvas size by pulling up the Size menu from the bottom toolbar as shown in FIG. 8. The canvas sizes are displayed along with the price. All sizes are shown as width by height, for example an 8×10 will be eight inches wide by 10 inches tall. The user has the option to change the orientation of the canvas by selecting portrait or landscape. Once the canvas size and orientation is chosen, the digital image in the preview window will display the user's choices.

The user places an image on the canvas and chooses the canvas size; now the user selects a background color for the canvas as shown in FIG. 6. The Canvas Color option gives the user several “suggested color” choices matching the image chosen. The user also has the option to choose a custom color from a provided color grid as shown in FIG. 7. The background color covers the digital canvas with the chosen color while keeping the text and images in the foreground. The background color can be changed at any point in the design process.

Additionally the user can insert text on the canvas as shown in FIG. 9. The user selects the Add Text option from the bottom tool bar. This action automatically adds text to the digital canvas in the preview window. The user places the text by clicking on the text and dragging it to the desired location on the digital canvas. The user sizes the font by using their mouse to grab one corner of the text and drag it away from or towards the center of the text as shown in FIG. 10. When the text is the desired size, the user releases the button on their mouse. The inserted text displays a Font Choices menu as shown in FIG. 11. This menu provides the user with a choice of font color using one of the two suggested colors or by picking a custom color from the provided color grid. The Font Choices menu also provides a list of True Type fonts for the user to apply to their inserted text. Additionally, the user can bold, italicize, or shadow the text. Finally through the Font Choices menu the user can move the inserted text layer forward or backward. This allows the user the option to place text over an image or behind an image.

The user will have the option to select a frame from a menu of options as shown in FIG. 12. The frame selected will be sized and displayed around the digital canvas generated by the flash application. The frame will be inserted for digital display only. The flash application will save the completed canvas art designed by the user without the inclusion of the frame element. The completed file will be sent to the printer and the chosen frame will be placed on the printed canvas to complete the canvas art before being shipped to the user.

In the second implementation of the art designer flash application the user chooses from a selection of templates to design their custom baby announcement art as shown in FIG. 13. The templates guide the user in placement of text and images. The user clicks on the Select Template button to bring up the thumbnail images of the pre-designed templates. The user chooses the desired template. The template is displayed on the digital canvas in the preview window. The user clicks on the template provided text to insert new text into the designated areas. The user clicks on the image to replace it with a selection from the Artwork menu.

In the third implementation of the art designer flash application, the user chooses from a selection of “sayings” such as “Best friends are we . . . my brother and me”, “Dream on little cowboy”, or “It's not easy being a princess” as shown in FIG. 14. These are meant to guide users in their creation of a Wonderful Words canvas. The user may also choose to insert custom text.

The user also has the option to frame or gallery wrap their completed art. The frames will be available for viewing in the flash application. The user selects a frame and it is displayed around the user designed art graphically displayed in the preview window. If the user chooses to gallery wrap, the flash application adds an additional two inches to each side of the art in order to stretch the canvas around 1.5″ gallery stretcher bars after it is printed.

To complete the order the user adds their customized art to the shopping cart. At this point the art designer application generates a pdf file of the user designed art ready for print. The user purchases the customized art, frame, and chooses a shipping preference. This completes the design process using the method and process laid out above.

### PARTS LIST

Digital Image Collection and Database, Flash Based Canvas Art Designer Application, Templates, Text, and Frames.

### BRIEF DESCRIPTION OF THE SEVERAL VIEWS OF THE DRAWINGS

FIG. 1 is a screen capture of the graphic user interface of the art designer flash application including menus and a preview screen. The menus include Artwork, Select Template (Baby Announcement only), Insert Saying (Wonderful Words only), Canvas Size, Canvas Color, Add Text, To Cart, and Help.

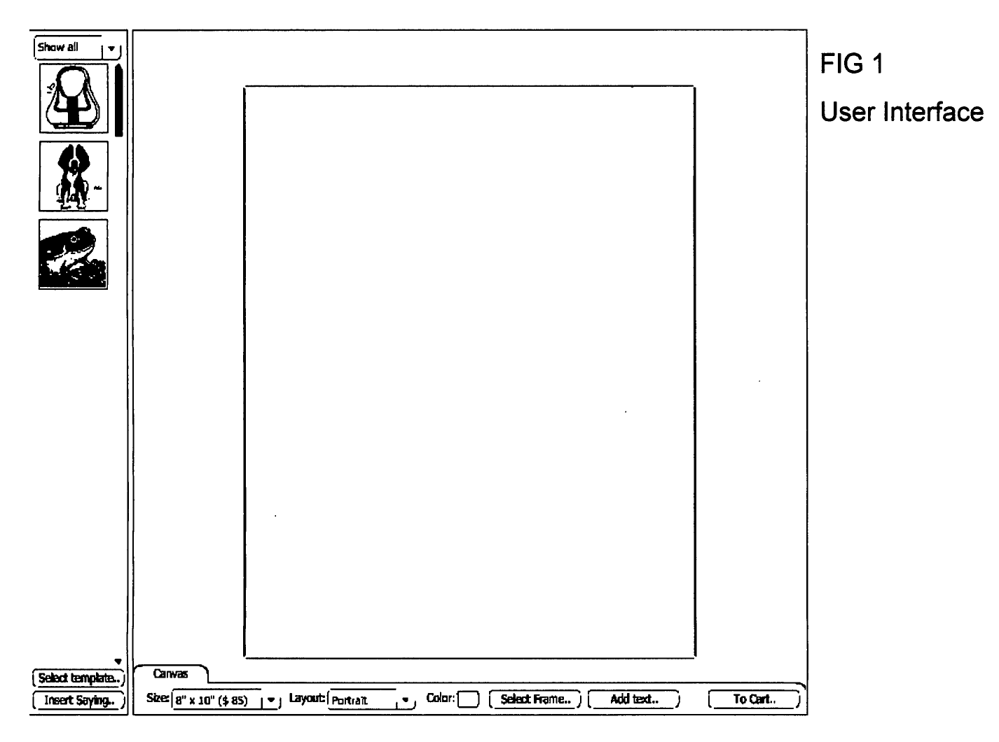

FIG. 2 is a screen capture of the Artwork menu. All of the digital hand painted artist renderings are organized into categories including; but not limited to: nature, sports, transportation, animals, style, etc. . . .

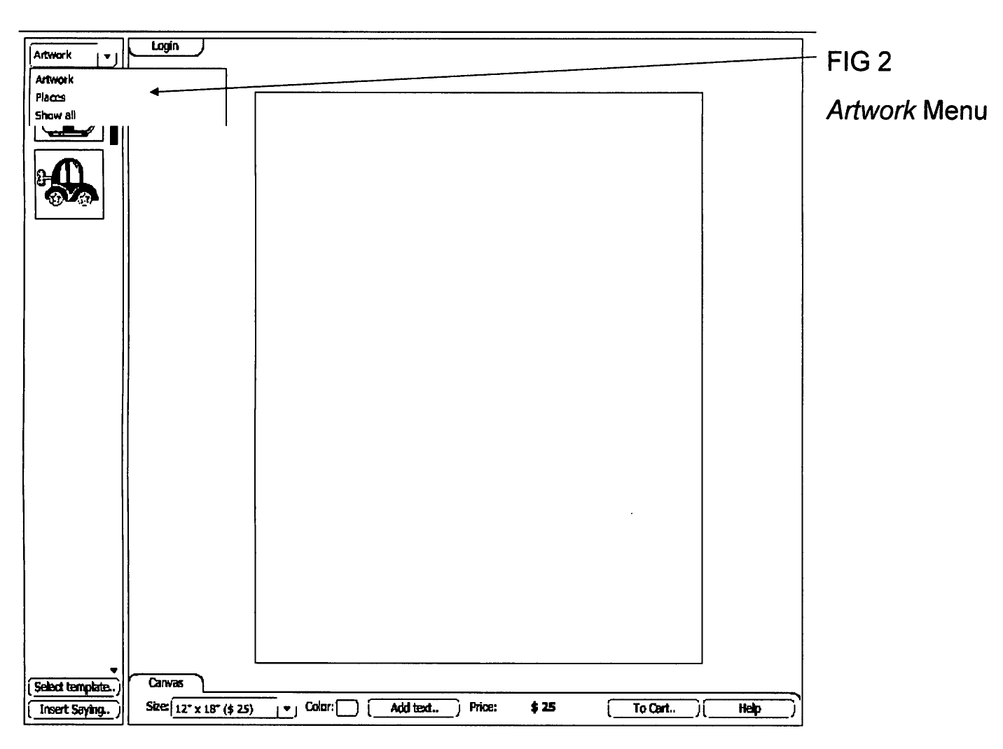

FIG. 3 is a screen capture of an image placed on the digital canvas. The user will click on the chosen image in the Artwork drop down menu to the left of the preview screen. The image and a default background color and size are generated by the flash application and displayed on the preview screen.

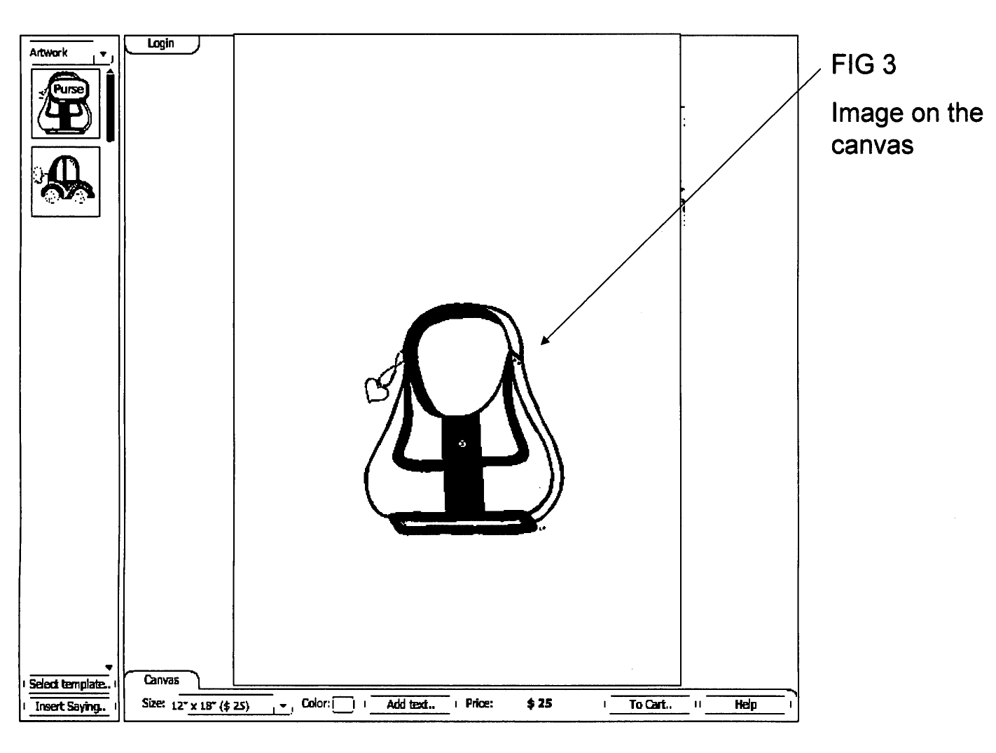

FIG. 4 is a screen capture showing the process of altering the image once placed on the digital canvas in the preview screen. The user will click on the image to rotate, change size or shape, and/or change the location of the image on the canvas.

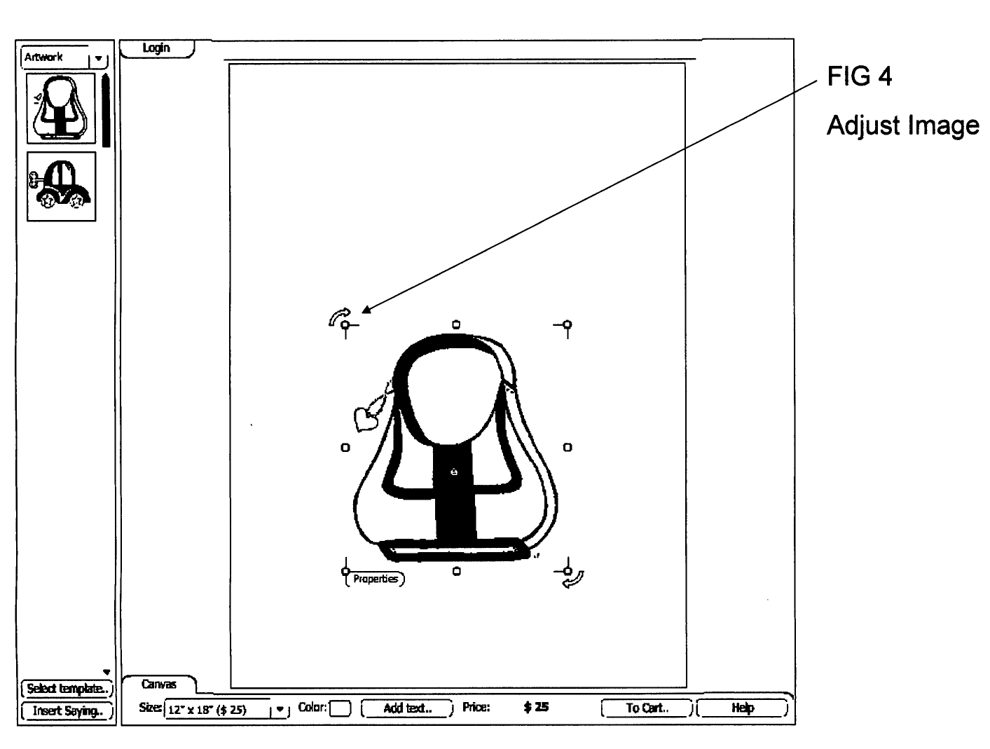

FIG. 5 is a screen capture demonstrating the Properties tab, displayed with the image on the canvas. By clicking on the properties tab, the user has the option to bring the image layer forward or backward or delete the image from the digital canvas.

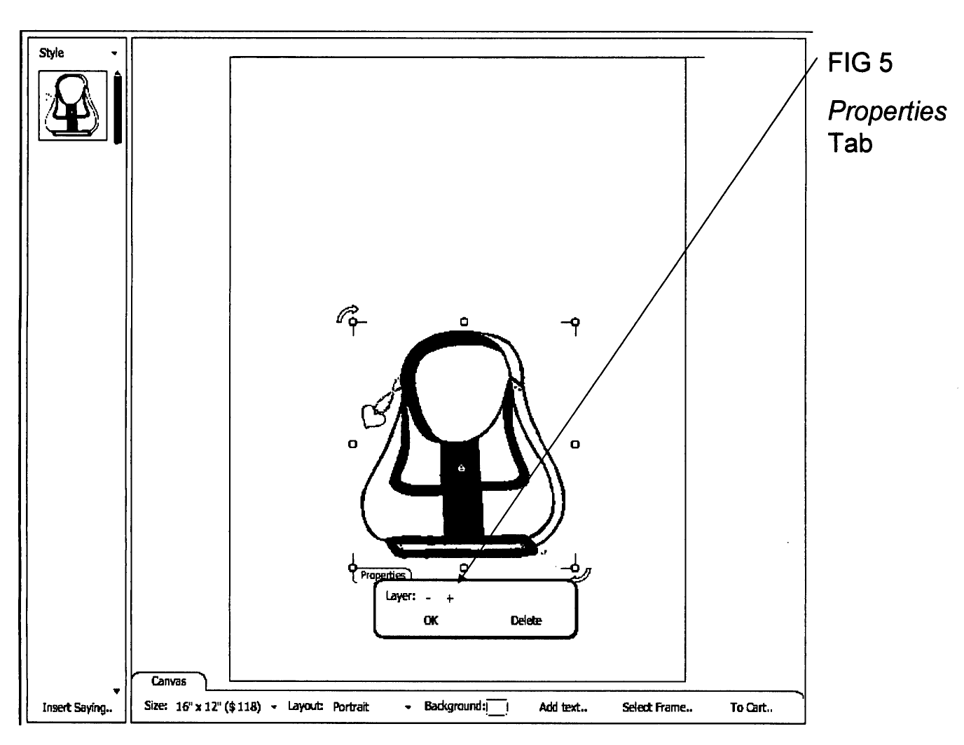

FIG. 6 is a screen capture illustrating the choice of canvas color provided to the user through the Canvas Color button on the bottom tool bar. The user is given a list of “suggested colors” that match the chosen image or the option to choose a custom color.

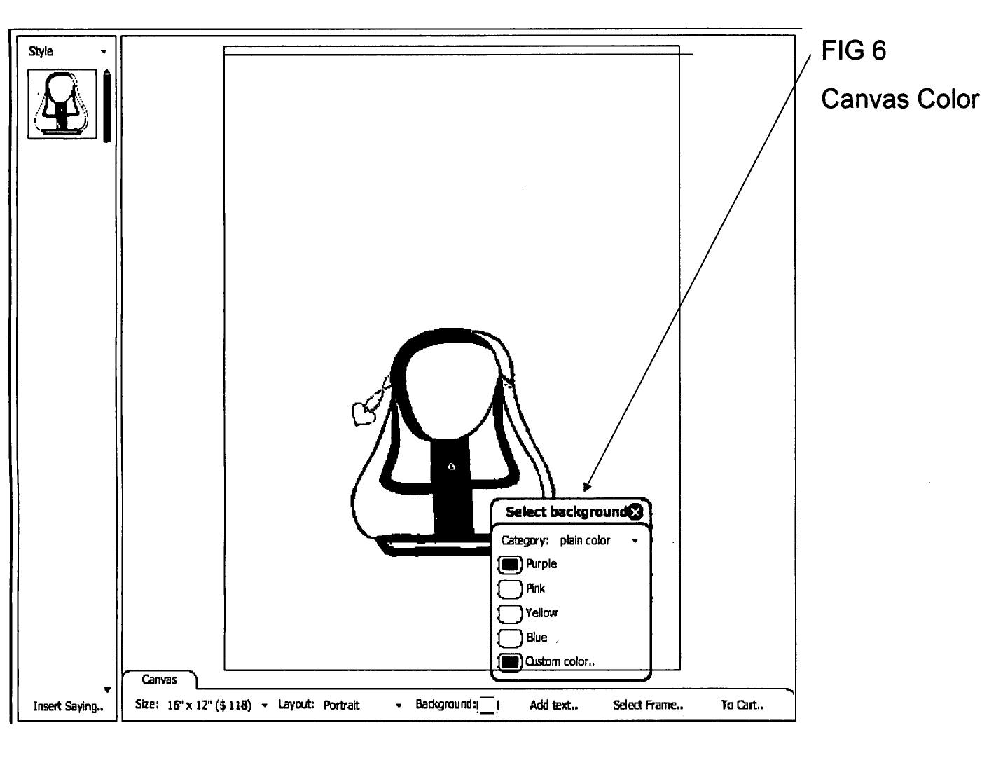

FIG. 7 is a screen capture displaying the custom color selector for the canvas background color if Custom Color is chosen by the user.

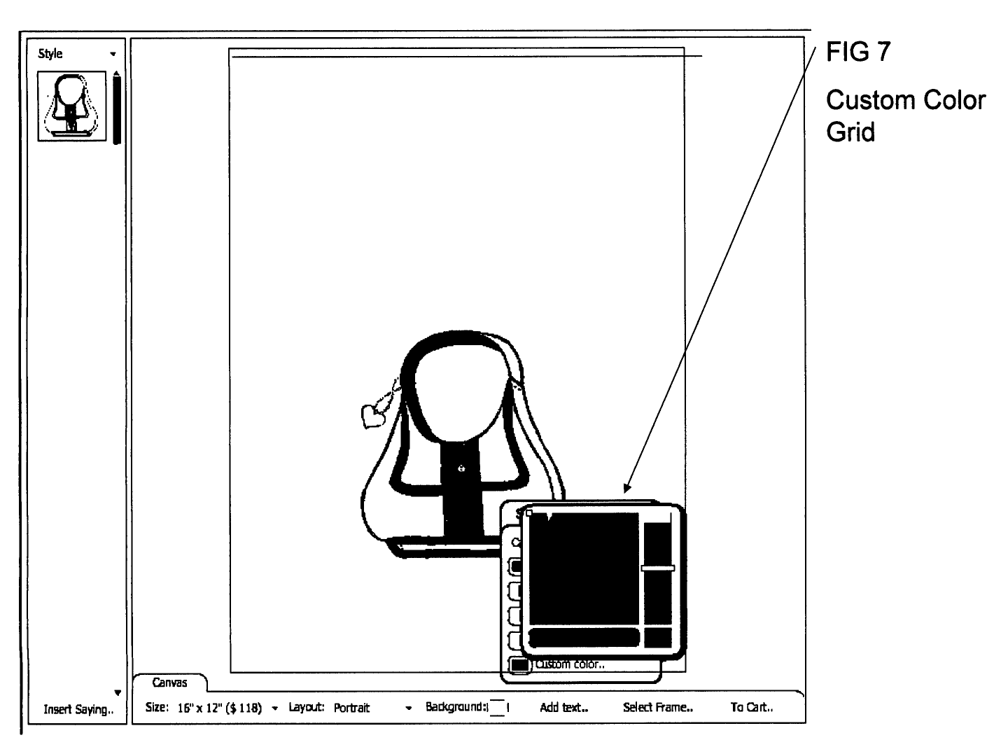

FIG. 8 is a screen capture illustrating how the user chooses a canvas size by clicking on the Size menu on the bottom toolbar. The user can choose from a list of sizes displayed by width and height. As a size is chosen, the digital canvas in the preview window will change accordingly.

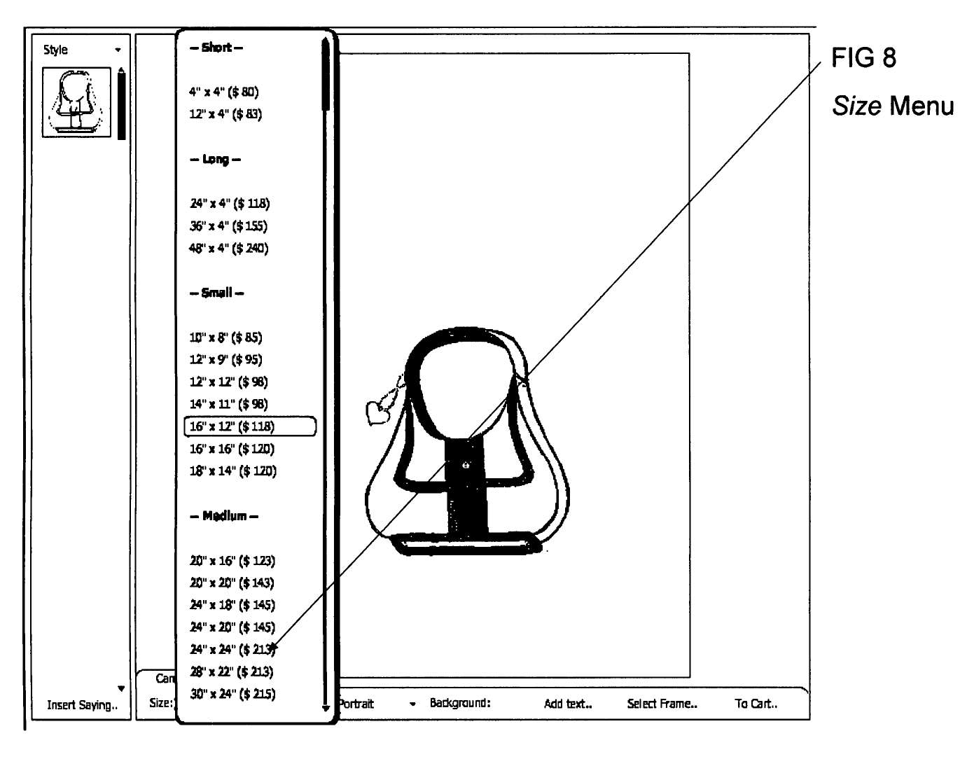

FIG. 9 is a screen capture showing the insertion of text by a user clicking on the Add Text button on the bottom tool bar.

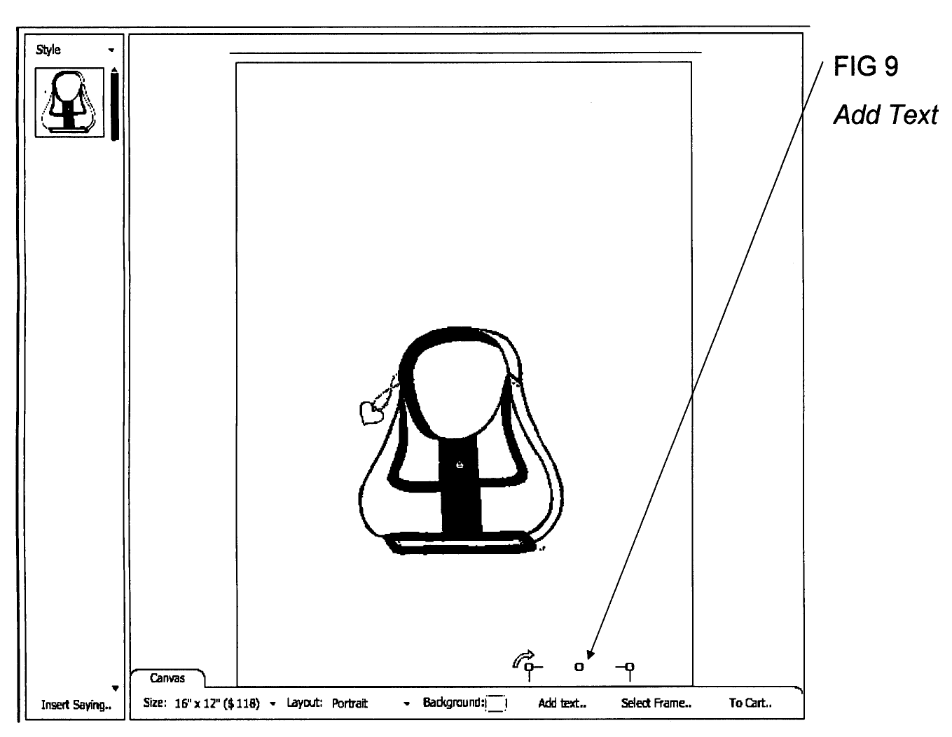

FIG. 10 is a screen capture demonstrating how a user can drag the text to any point on the canvas by clicking on it with their mouse and dragging it to the desired location. Once the button on the mouse is released, the text will be dropped in that spot, but can be moved again by repeating this process. The user can size the text by grabbing the corners, by using their mouse, and dragging them until the text is the desired size.

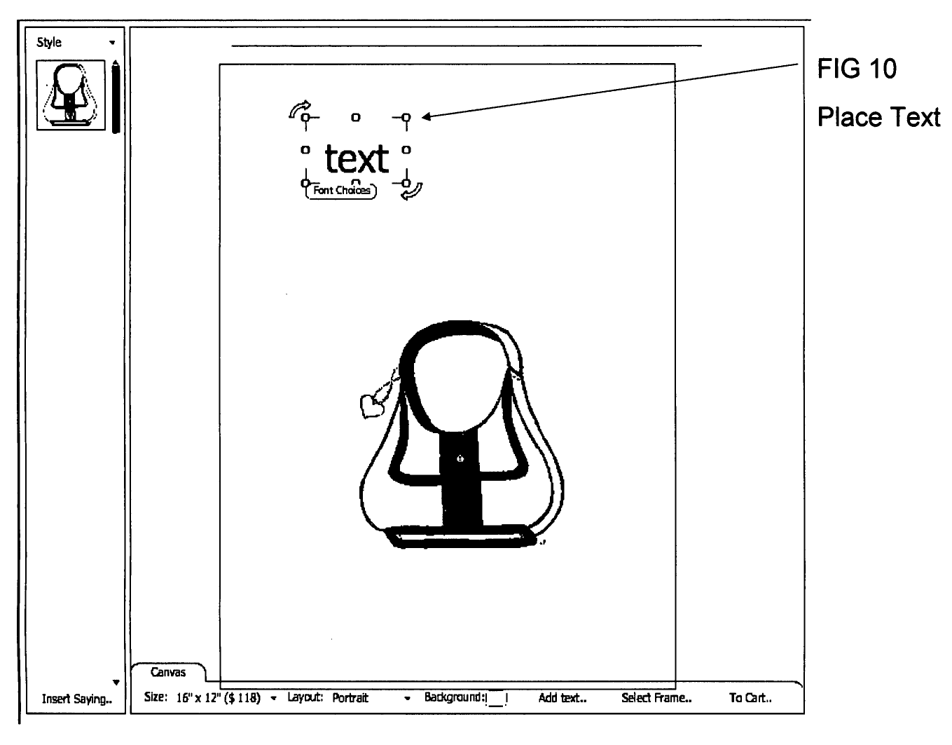

FIG. 11 is a screen capture illustrating how a user can manipulate the font, by clicking on the Font Options tab. The options within this menu include font color, moving the font layer forward or backward, font style, bold, italics, and shadow. There is also an option to delete the font from the canvas.

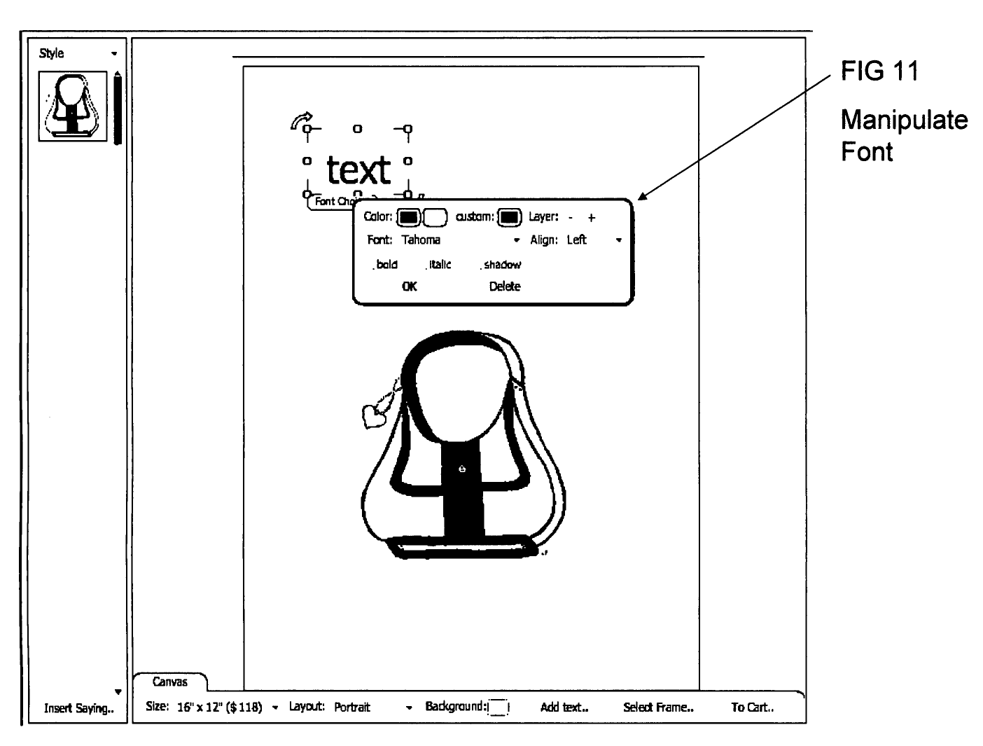

FIG. 12 is a screen capture of the framing process. The user chooses a frame from the list of options. The frame is displayed on the digital canvas created by the user. The flash application does not include the frame in the print ready file generated by the program. It is displayed only as a visual for the user in determining which frame to choose.

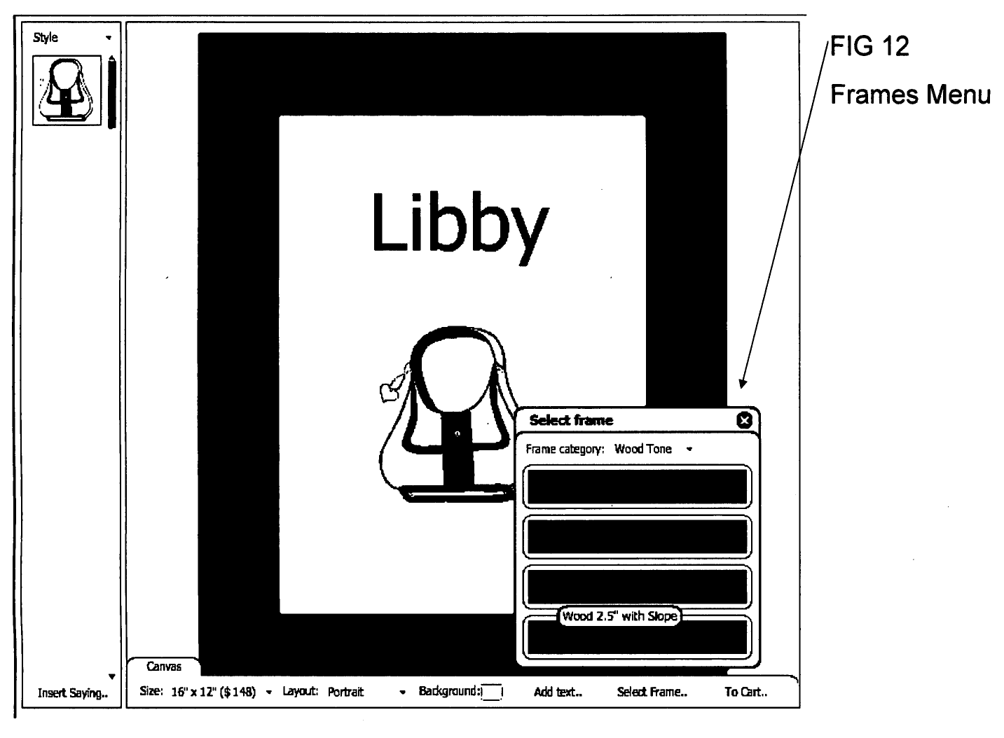

FIG. 13 is a screen capture displaying the templates option in the second implementation of the art designer, the Birth Announcement product category. The user can choose from any number of templates previously designed and inserted into the flash application. On each template the text and image can be replaced with other text and image selections chosen by the user.

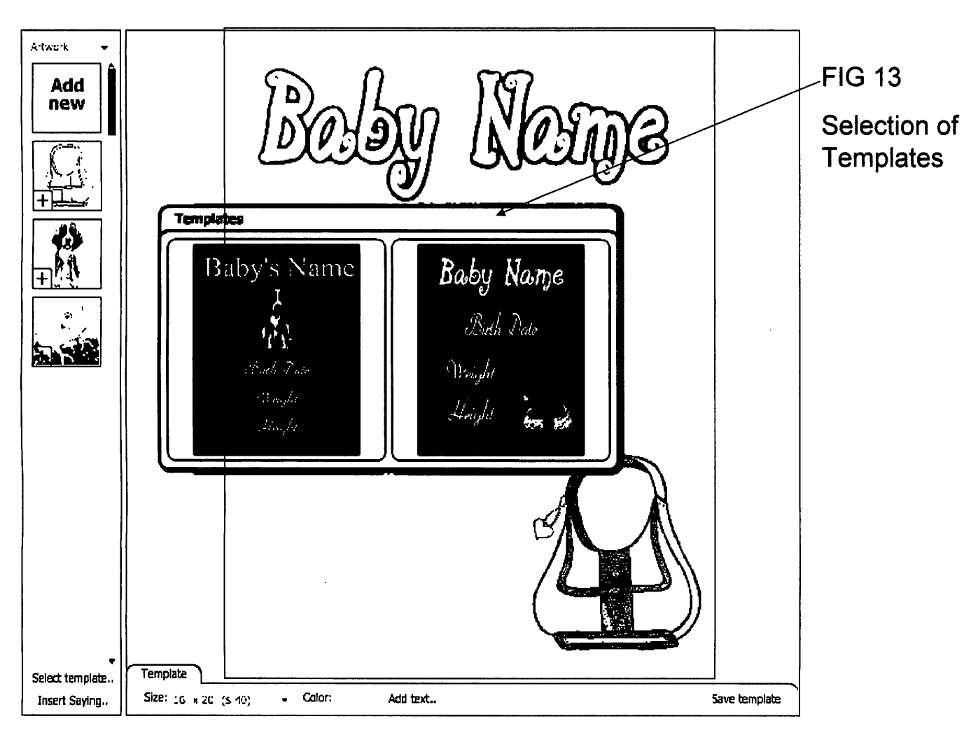

FIG. 14 is a screen capture demonstrating the insert text option in the third implementation of the art designer, the Wonderful Words product category. The user can add text, provided by the flash art designer application, to the digital canvas. For example: when the user clicks on Insert Saying, a list of sayings such as “All you need is faith, trust, and a little fairy dust” appears in the displayed menu. The user will select a saying and add it to their canvas. The text can then be manipulated in the same manner as the text in the Build Your Own art designer.

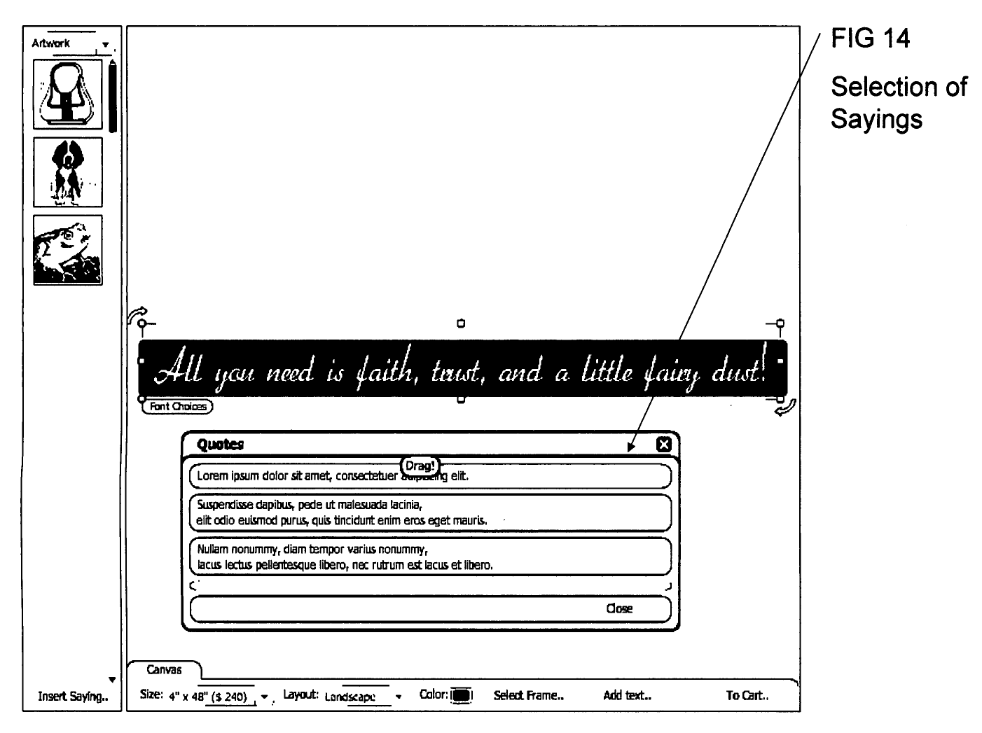

We claim:

1. A method of offering customized art to a user (here and after the person using the application to design art will be referred to as the “user”). Said method comprising the steps of: (a) accessing a digital image; (b) accessing a set of design choices for configuration of customized art; (c) accessing a selection of frame choices; (d) display of customized art during design phase; (e) generation of digital file ready for print.

2. The method as recited in claim 1(a), in which said selection of digital images consist of hand-painted renderings converted into high resolution digital files for use in the html based art designer flash application. The hand-painted rendering are provided by hired artists or submitted by the user.

3. The method as recited in claim 1(b), in which the user is provided a set of conditions applicable to the custom product, including the size of the canvas provided through a menu of different sizes. The chosen size will produce a real-time scaled digital image of the canvas.

4. The method as recited in claim 1(b), further including a color spectrum in which a color is chosen and applied to the real-time digital image of the canvas.

5. The method as recited in claim 1(b), further including the option to insert text; characters determined by the user, with ability to choose font, font color, bold, italics, and shadowing effects.

6. The method as recited in claim 1(c), in which said selection of frames are provided through the flash application. Chosen frame demonstrated on digital canvas for viewing purposes only.

7. The method of claim 1(d) comprises of the flash application generating a real time preview of the digital image as constructed by the user and saving the digital content as a print ready file.

8. The method of claim 1(e) comprises of the flash art designer application's generation of a high resolution, over 300 dpi, digitally formatted file of the users designed content stored on the server and ready to be sent to the canvas printer.
